(19) United States
(12) Patent Application Publication
(10) Pub. No.: US 2026/0054806 A1
(43) Pub. Date: Feb. 26, 2026

(54) OFFSHORE APPARATUS FOR EXTRACTING ENERGY FROM A FLUID AND METHODS FOR ITS USE

(71) Applicant: Offshore Energy Solutions ApS, Copenhagen (DK)

(72) Inventors: Niels Peter ELMBO, Copenhagen (DK); Hesam MIRZEN, Copenhagen (DK)

(73) Assignee: Offshore Energy Solutions ApS, Copenhagen (DK)

(21) Appl. No.: 19/104,925

(22) PCT Filed: Aug. 21, 2023
(86) PCT No.: PCT/IB2023/058333

§ 371 Date: Feb. 19, 2025

(30) Foreign Application Priority Data
Aug. 20, 2022 (AU) 2022902383

(51) Int. Cl. B63B 35/44; B63B 1/12; F03B 13/14

(52) U.S. Cl. CPC B63B 35/44; B63B 1/12; F03B 13/14; B63B 2035/4466; F05B 2240/93

(57) ABSTRACT

An apparatus is disclosed for extracting energy from an oscillating working fluid. The apparatus comprises a housing 50 which is positioned on a floatable support structure 120/130 that is arranged in use to float on a body of water having waves. The housing has an internal flow passage for receiving air; and a turbine 60/70 which is disposed at the housing. A unidirectional flow of the air is drawn out of the chamber by the use of an OWC created by respective incoming and outgoing flows of waves. The unidirectional flow of the OWC acting on the turbine 60/70 is responsive to, and generated by, only one of the flows of the waves.

### TECHNICAL FIELD

This disclosure relates generally to energy generation, and more particularly to an apparatus arranged for use in an offshore location for energy extraction from ocean wave swells and the conversion of that energy to electrical energy. The disclosure is also concerned with the methods of use of that apparatus, as well as methods for optimising the efficiency of the capture of energy using such an apparatus.

### BACKGROUND OF THE DISCLOSURE

Numerous types of wave power generation systems have been proposed in the art. Such systems are based on the principle of using the motion of waves to cause a rotary movement of a turbine to drive a generator to produce electricity.

As a result of the oscillatory motion of wave swells in the ocean, an oscillating water column (OWC) will experience both inward and outward flows of waves. Most of the known prior art wave-power generation systems employ several fluid flow ducts in arrangements which contain the OWC, and certain amounts of displaced air, which are connected to a turbine. In such systems with frequently reversing air flow conditions present which are caused by a repeated displacement of the air in a duct, the usual design requirement has been that the turbine must be able to handle reversible airflows. In other words, the required turbine design will be bi-directional.

However, bi-directional turbines often have the disadvantage that they are complex in configuration and expensive to manufacture, and they cannot withstand the harsh environmental conditions provided by the ocean (salt water, high or rough seas bringing large or unpredictable forces) over long periods of time.

An alternate prior art wave-power generation system has been developed using a simplified arrangement of ducts which contain the OWC, and which are connected to a uni-directional turbine, as shown in the prior art PCT patent application WO2018/071963 (Denniss). In that system, the air flow conditions involve the discharge of air to atmosphere when upward displacement of air in a duct occurs, due to the inward flow of fluid (water) in the OWC. When the OWC is reversed, and an outward flow of water is displaced in a downward direction, air is drawn into the ducts via the turbine, which was chosen to avoid the use of reversible, or bidirectional airflow turbines. In other words, the preferred turbine design is unidirectional.

In the use of either type of bidirectional or unidirectional turbine with an OWC, there are losses in efficiency during the conversion of the kinetic energy of the flow(s) of gas into a rotational mechanical energy of the turbine, which may be able to be improved by employing more efficient turbine designs of larger scale size. However, the design features of the known prior art designs of OWC apparatus have been quite intricate, meaning that there is little flexibility available to operators to change the design parameters, and so there is a mismatch between the overall size and capacity for movement of water in and out of an oscillating water column, and the size of waves found in body of water. This is especially the case if a location far offshore is preferred (for example in deep waters 20-50 km from the coast) where it should be possible to capture very large quantities of power from great ocean wave swells, thus forming the basis for a large-scale power generation facility. Localisation of the design configuration of such apparatus has not been successfully achieved commercially, in such extreme wave environment situations. A misalignment between the scale of the OWC facility and the size of the incoming and outgoing waves can result in a low efficiency of conversion of wave energy.

There is a need for an improved system design of OWC which has the practical flexibility to be able to convert large ocean wave swells into electrical power, as well as achieve low power generation costs by efficiencies of scale.

### SUMMARY OF THE DISCLOSURE

In a first aspect, the present disclosure provides embodiments of an apparatus for extracting energy from an oscillating working fluid, the apparatus comprising:
a housing which is positioned on a floatable support structure that is arranged in use to float on a body of water having waves, the housing defining an internal flow passage for receiving the oscillating working fluid; and
an energy conversion unit disposed at the housing, in fluid communication with the oscillating working fluid in the internal flow passage, such that in use a unidirectional flow of said oscillating working fluid acts on the energy conversion unit; and
the housing also being arranged to contain an oscillating water column that is in fluid communication with both the body of water and with the internal flow passage in use, such that:
   the oscillating water column is established within the housing as a result of repeated movements of water from respective incoming and outgoing flows of the waves; so that
   the unidirectional flow of the oscillating working fluid acting on the energy conversion unit is responsive to, and generated by, only one of said flows of the waves,
      wherein said fluid communication between the body of water and the oscillating water column occurs via an opening which is located at a part of the floatable support structure which is continuously submerged below waterline, during normal operational use.

Throughout this specification, the term “floatable support structure” may be in reference to a watercraft which, in relation to a surrounding body of water upon which it floats by reason of buoyancy, is capable self-movement thereacross. Examples of self-moving vessels include motorised ships, larger-sized boats, tankers, freighters or other hulled vessels such as twin-hulled catamarans (which have a platform positioned between parallel boat hulls), all of which are at least partly submersible in the body of water in normal operational use.

The term “floatable support structure” may also be used in reference to a watercraft which, in relation to a surrounding body of water upon which it floats by reason of buoyancy, is capable of movement by being tugged or towed thereacross. Examples of this include moveable floating structures which are normally not motorised, for example a semi-submersible platform, pontoon or barge.

Throughout this specification, the term “waterline” refers to the position of a surface-air interface of the body of water, such as the upper surface of the ocean or lake upon which the floatable support structure, or a vessel, is moved or moored.

In certain embodiments, the effect of the unidirectional flow of the oscillating working fluid acting on the or each energy conversion unit is that the configuration of the energy conversion unit(s) be operably unidirectional.

In certain embodiments, the apparatus comprises one or more flow control device(s) which is/are disposed at the housing and arranged in use to be in fluid communication with the internal flow passage, for selectively changing the configuration of the internal flow passage between one where the unidirectional flow of the oscillating working fluid acts on the energy conversion unit, to another configuration in which a flow of said oscillating working fluid bypasses the energy conversion unit.

In certain embodiments, at least one flow control device is configured in use to operate separately and sequentially to the energy conversion unit, so that:
the unidirectional flow of said oscillating working fluid enters the flow passage and acts on the energy conversion unit, and then
the flow of said oscillating working fluid exits the flow passage via the one flow control device, and bypasses the energy conversion unit.

In one specific form of this, the unidirectional flow of the oscillating working fluid acting on the energy conversion unit is associated in use with a suction pressure in the internal flow passage created by the fall of a passing wave, which causes the oscillating water column to flow out of the housing;
and furthermore, wherein the flow of the oscillating working fluid exiting the internal flow passage via the flow control device is associated with a rise in pressure therein, caused by an incoming wave flowing into the oscillating water column in the housing.

In certain embodiments, the apparatus comprises at least one flow control device which is configured in use for only the unidirectional flow of said oscillating working fluid to enter the internal flow passage thereby, and to act on the energy conversion unit, otherwise closed.

In certain embodiments, the apparatus further comprising a second energy conversion unit which is disposed at the housing and which is arranged in use to be in fluid communication with the internal flow passage, wherein as the flow of said oscillating working fluid exits the internal flow passage via the one flow control device, it acts on the second energy conversion unit, which is configured to cooperate therewith.

In an alternative embodiment, at least one flow control device is configured in use to operate separately and sequentially to the energy conversion unit so that:
the unidirectional flow of said oscillating working fluid exits the flow passage and acts on the energy conversion unit, and then
the flow of said oscillating working fluid enters the flow passage via the one flow control device, and bypasses the energy conversion unit.

In certain embodiments, the apparatus comprises at least one flow control device which is configured in use for only the unidirectional flow of said oscillating working fluid to exit the internal flow passage thereby, and to act on the energy conversion unit.

In certain embodiments, the apparatus further comprises a second energy conversion unit which is disposed at the housing and which is arranged in use to be in fluid communication with the internal flow passage, wherein as the flow of said oscillating working fluid enters the internal flow passage via the one flow control device, it acts on the second energy conversion unit, which is configured to cooperate therewith.

In certain embodiments of either alternative, the configuration of the or each flow control device is moveable to become open or closed to the flow of the oscillating working fluid in response to changes in the pressure thereof, said movement being of an element which covers a cross-sectional opening passage of the flow control device, optionally being one of a hingedly, slidably, rotatably or tiltably moveable element, wherein the or each flow control device is operably configured to function as a one-way valve.

In certain embodiments, the oscillating water column is contained in use within an elongate chamber which depends from the opening. In one form of this, some, or all, of the elongate chamber is located at an interior of, or is defined by, the housing.

In a further specific form of this, the elongate chamber is circular in its horizontal cross-section, and cylindrical.

In certain embodiments, the floatable support structure includes a vessel, and the opening is located in a hull of a vessel at an underside surface region thereof, the opening forms a cavity or recess thereinto which faces into the body of water in normal operational use. In one specific form, the cavity or recess is a chamber known as a moon pool or a wet porch.

In certain embodiments, the or each energy conversion unit is disposed at a part of the housing where it is arranged to be in fluid communication with the internal flow passage, at a part of the floatable support structure which is continuously above the waterline during normal operational use. In one form of this, said part of the floatable support structure where the or each energy conversion unit is located, is at or near an upper surface region thereof, which faces away from the body of water in use.

In certain embodiments, the generally elongate chamber, which is defined at least in part by the housing, is arranged to extend from an in use underside surface region of the floatable support structure, to a position in which it is in fluid communication with the internal flow passage of the part of the housing which is at an upper surface region of the floatable support structure.

Throughout this specification, the term “underside surface region” refers generally to the base region of the floatable support structure being referred to. As there are a wide variety of possible shapes of such structures, the base portions can also be of many quite different designs, such as the hull of a ship bent upwards from a central spine, or the flat underside shape of a floating platform.

In certain embodiments, the energy conversion unit includes a turbine comprising a rotor with a central hub and a plurality of blades arranged about and extending from the periphery of the hub, the rotor disposed within a rotor housing in fluid connection with the internal flow passage, whereby the shape of the blades and their orientation in relation to the hub facilitates a unidirectional axial flow of oscillating working fluid through the rotor housing.

In certain embodiments, an electric generator is configured for rotation by the turbine to generate electrical energy. In certain embodiments, a drive shaft is coupled to the central hub, as well as to said electric generator.

In certain embodiments, the oscillating working fluid is air, the flow of which is generated by oscillations of the oscillating water column which is in fluid communication with the internal flow passage, at an interior of the housing.

In certain embodiments, the apparatus further comprises a locating device for locating the floatable support structure in approximately fixed relation to a predetermined position for its intended operational use, but in such a manner that it can reposition itself, or be repositioned, in relation to a prevailing motion or direction of waves flowing in said body of water.

In certain embodiments, the locating device is a gravitational anchor structure positioned underneath the floatable support structure on a seabed of the body of water, which is connected to said vessel by tensile cables in use.

In certain embodiments, the locating device is a gravitational anchor of the floatable support structure which is directly connected to a seabed floor when deployed in use.

In such mooring arrangements, the floatable support structure, is tethered or anchored so as to create a “near” to non-vertical moving structure in wave and swell conditions, but still with sufficient flexibility to respond to changes in buoyancy created by ballasting. Such moorings are serving multiple purposes. In the open sea environment, the ship cannot be allowed to drift away from the selected location, in case it impacts other ships which are also anchored in a similar way. The position of the ship relative to the waterline, the extent of the moonpool opening, and the shapes of the moonpools which are open, are all variables which are preselected depending on a knowledge of the sea state conditions for waves in that location, and whether power can be satisfactorily generated.

Some of the selected types of mooring for the floatable support structure include a “turret mooring” arrangement of conventional mooring lines to tether it to the sea floor, and at a pre-selected water draught, as well as a “spread mooring” arrangement using two groups of conventional mooring lines near opposing ends of the ship to tether it to the sea floor, and at a pre-selected water draught. These arrangements confine the ability of the ship to move around in a horizonal plane. A spread mooring is typically used for shallower water mooring of ships. A turret mooring allows the floatable support structure to pivot rotationally, so that its elongate axis may become aligned parallel with the direction of the crests of the wave fronts, in which case the moonpool entry openings located on the side flanks of the vessel are the best location for intakes into the OWC for the vertically upward and downward wave fronts.

As a floating structure in use, the floatable support structure provides the significant advantage that it can receive the flow of waves at the most efficient direction to recover maximum energy from the wave trains, as well as be ballasted.

In certain embodiments, the floatable support structure comprises a platform attached to two or more buoyant vessels which retain the platform above the level of the body of water having waves, the platform and optionally the vessel(s) being arranged to support a plurality of the housings in position so that, when deployed, each housing is configured to contain an oscillating water column which is arranged to be in fluid communication with both the body of water, via a respective opening of the housing, and with an internal flow passage located in the housing.

In certain embodiments, the floatable support structure is arranged to support an array of said housings, such that the elongate axis of the vessel is orthogonal to the crests of the wave fronts, so the housings are located in rows across the width of the vessel, each one oriented for simultaneous intake of the vertically upward and downward wave motion of the wave fronts.

In another aspect, the present disclosure provides embodiments of a method of extracting energy from an oscillating working fluid, the method including the steps of:
positioning a housing on a floatable support structure that is arranged to float on a body of water having waves, the housing defining an internal flow passage for receiving the oscillating working fluid;
arranging an energy conversion unit to be in fluid communication with the oscillating working fluid in the internal flow passage, such that in use a unidirectional flow of said oscillating working fluid acts on the energy conversion unit;
further arranging that said housing contains an oscillating water column that is in fluid communication with both the body of water and with the internal flow passage in use, such that:
   said oscillating water column is established within the housing as a result of repeated movements of water from respective incoming and outgoing flows of the waves; and
   the unidirectional flow of the oscillating working fluid acting on the energy conversion unit is responsive to, and generated by, only one of said flows of the waves;
wherein the method comprises the further step of arranging the region at which fluid communication between the body of water and the oscillating water column occurs to be via an opening located at a part of the floatable support structure which is continuously submerged below waterline, during its normal operational use.

In certain embodiments of that aspect, the features of the apparatus are just as disclosed in relation to the first aspect.

In another aspect, the present disclosure provides embodiments of a method for retrofitting an apparatus in accordance with any features or steps of the other aspects, on a floatable support structure that is arranged for use on a body of water having waves.

In another aspect, the present disclosure provides embodiments of a method for arranging an industrial process or an electrical storage system to be installed on board an apparatus for extracting energy from an oscillating water column in accordance with any with any features of the other aspects, wherein in use the industrial process consumes, and/or the storage system stores, at least some of the extracted electrical energy, for end use purposes which include, but are not limited to: desalination of water; electrolysis, or electrolytic conversion, of water; charging of batteries or other long-term energy storage or chemical storage; supporting equipment for windfarms, including associated substations and AC/DC convertors; data centres; and other auxiliary and process equipment for the aforementioned.

Also disclosed herein is an axis of the elongate chamber is arranged to extend from the opening towards an uppermost surface of the floatable support structure, and generally parallel to an imaginary vertical plane extending along an elongate axis thereof. For example, on a ship the opening may be positioned at a curved portion of the hull below waterline, between the central spine of the keel and the straight upright side wall of the ship. An elongate chamber can extend upwardly within the housing from that opening on the vessel hull, through a vertical height through which an oscillating water column may rise therewithin. If the elongate chamber is to be directed directly upwardly within the housing from that opening on the vessel hull, to maximise the vertical height through which an oscillating water column may rise therewithin, then the upward direction of the elongate chamber is parallel to said imaginary vertical plane extending along the elongate axis (or central spine) of the ship.

Also disclosed herein is where the elongate chamber shows a tapered reduction in its horizontal cross-sectional area when moving in a direction from the opening towards the internal flow passage, both to accelerate the incoming flowrate from the body of water into the oscillating water column, and effect displacement of the oscillating working fluid at a faster rate of flow.

Also disclosed herein is where the elongate chamber shows a tapered increase in its horizontal cross-section area when moving in a direction from the opening towards the internal flow passage, to maximise a volume of water accommodated, and its consequential gravitational potential energy, from the incoming flow of waves into the oscillating water column, which is energy subsequently available for conversion into kinetic energy of the flow of oscillating working fluid acting on the energy conversion unit when the oscillating water column responds to the outgoing flow of waves.

Also disclosed herein is an apparatus which further comprises a control system capable of continuously adjusting one or more functional features of the said apparatus, to the extent that a frequency of incoming and outgoing water flows in the (or where there are a plurality of each of them, each) oscillating water column(s) which substantially corresponds to a respective frequency of the incoming and outgoing waves in the body of water, to thereby optimise the efficiency of, or the extent of, conversion of wave energy by the apparatus.

Also disclosed herein is an apparatus which comprises a control system which is capable of continuously adjusting several functional features of the said apparatus, in each case to extent that a frequency of the incoming and outgoing water flows in the (or where there are a plurality of each of them, each) oscillating water column(s) can more closely correspond to a respective frequency of the incoming and outgoing waves in the body of water. While it can be the case that each physical change to the functional features of the apparatus can improve the energy conversion efficiency of the oscillating water column(s), it may be that multiple, simultaneous changes to those functional design features which optimises the efficiency of, or the extent of, conversion of wave energy.

It is believed that having an oscillating water column operating in alignment with the prevailing ocean conditions leads to maximum efficiency of conversion of wave swell energy into potential energy which is held in the form of a column of water in an elongate chamber. In turn, in an efficient oscillating water column, as the water column leaves the elongate chamber under suction created in alignment with the fall of a passing wave, the release of that potential energy is imparted as kinetic energy to create a moving air flow, being the displacement of air as the oscillating working fluid in the internal flow passage, such air flow in turn actuating a turbine to generate electrical energy.

Also disclosed herein is an apparatus which may be used operationally to provide continuous adjustment of the frequency of incoming and outgoing water flows in the oscillating water column(s) to match the incoming and outgoing wave frequency from an adjacent body of water. Whether the:
floatable support structure is raised or lowered in the water by the removal or addition of ballast; and/or
combination of multiple, but differently-shaped elongate chambers each having different resonant frequencies, are selected; and/or
physical size of the opening between some moonpool chambers and their respective adjacent elongate chambers is adjusted by some proportion;
it is the case that each physical change is aimed at improving energy conversion efficiency of the oscillating water column(s).

Also disclosed herein is an apparatus in which a control system ensures that the floatable support structure is arranged to be ballasted in use to a degree which maximises its submerged draught or depth relative to the waterline, consequentially increasing the relative distance between the opening and an upper surface of the body of water, and thereby maximising both the available vertical height through which said oscillating water column can move during use, and its energy recovery potential.

It is believed that that, since it is a floating structure, a vessel can be properly ballasted to maximize its draught in order to receive the wave sets at the most efficient depth and vessel direction, and to recover maximum energy from the wave sets. Continuous adjustment of the vertical draught of the wave moonpool opening in response to the movement of water measured by a sensor detection system, can thus lead to optimization of the energy absorption of the wave energy.

Throughout this specification, the term “draught” in relation to a floatable support structure or a vessel (e.g. a ship) refers to the vertical distance between the waterline and the bottom point of the hull (keel) of that vessel.

Also disclosed herein is an apparatus which continuous changes to increase ballasting of the floatable support structure are effected by controlling the use of a pump to introduce water into one or more storage tanks located on board the floatable support structure which house the water in use, and conversely, decreasing the ballasting of the floatable support structure is effected by controlling the use of a pump to withdraw water from said storage tank(s) for discharge into the body of water.

Also disclosed herein is an apparatus which has, a plurality of housings, each of which contains one or more oscillating water columns in use, are arranged on the floatable support structure, each oscillating water column being in fluid communication with both the body of water, via a respective opening of the housing, and with an internal flow passage of the housing.

Also disclosed herein is an apparatus, in which each floatable support structure is arranged with an array of oscillating water columns in use, at least some of said oscillating water columns are arranged to be of different internal dimensions to the others, thereby having a different natural resonant frequency, and wherein the control system is arranged to individually select and deploy at least some of said oscillating water columns in use, by adjusting an available open cross-sectional area of their respective opening(s) to permit an oscillating water flow to be achieved.

It is believed that an array of moonpool openings and associated elongate chambers that each have different natural resonant frequencies, means that the control system can continuously select which moonpool is to be opened for the OWC frequency to be tuned to match the energy of the waves being received from the surrounding body of water (for example, an ocean environment) in order to recover maximum energy from the wave sets. Continuous adjustment can be made regarding the selection of which of the available OWC, and its respective opening, are to be deployed in response to the movement of water measured by a sensor detection system, and in turn this can lead to optimization of the energy absorption of the wave energy.

Also disclosed herein is a control system so that changes to fluid flow rate in some or all of said oscillating water columns in use can be individually controlled by adjusting an available open cross-sectional area of their respective opening(s).

Also disclosed herein is an apparatus which has an oscillating water column comprises at least one flow control device which is in direct fluid communication with an opening, and which is arranged in use to adjust the available open cross-sectional area thereof to any point between a first configuration in which the flow control device is fully open and a second configuration in which the flow control device restricts water flowing therethrough, for example by being of a shape which covers a cross-section of the opening passage between the moonpool chamber and the elongate chamber.

Also disclosed herein is an apparatus in which the flow control device, or a part thereof, is fitted with a control mechanism to control its movement, between the first and second configurations. In some forms of this, the flow control device, or a part thereof, is one of hingedly, slidably or rotatably moveable.

It is believed that advantage of having a plurality of moonpool openings and associated elongate chambers, whether or not those elongate chambers are of different internal dimensions and have a different natural resonant frequency to each other, is that the control system can continuously select the extent to which the moonpools are to be opened so that the OWC frequency can be tuned to match the energy of the waves received from the surrounding water (eg. an ocean environment) to recover maximum energy from the wave sets. Continuous adjustment of the open area of the OWC openings in response to movement of water as measured by a sensor detection system, can lead to optimization of the energy absorption of the wave energy]

Also disclosed herein is an apparatus which, further comprises a flow control means which is disposed at the housing and is arranged in use to be in fluid communication with the internal flow passage, for selectively changing the configuration of the internal flow passage between:
an active configuration in which the direction of the oscillating working fluid acting on the energy conversion unit is responsive to, and generated by, one of said flows of the waves, and
a bypass configuration in which, said oscillating working fluid bypasses the energy conversion unit, as it exits the internal flow passage, and without any significant quantity of working fluid leaving the internal flow passage via the energy conversion unit,
which therefore means that the effect of said direction of flow of the oscillating working fluid acting on the energy conversion unit is that the energy conversion unit shall be operably unidirectional in configuration.

Also disclosed herein are some examples in which, in use, the flow control means and the energy conversion unit are configured to operate separately and sequentially such that a flow of working fluid exits the internal flow passage via the flow control means, and a flow of working fluid enters the internal flow passage via the energy conversion unit. In such arrangements, the housing is arranged to contain an oscillating water column located adjacent the body of water, and the direction of the oscillating working fluid acting on the energy conversion unit is associated with the fall of a passing wave.

Also disclosed herein are embodiments of an apparatus arranged for controlling the frequency of movement of water in an oscillating water column when said apparatus is placed in fluid communication with a body of water with waves in use, the apparatus comprising:
a housing for receiving the oscillating water column, the housing comprising:
a first region arranged in use to be submerged below a surface level of the body of water in which it is located, having an opening arranged for receiving the incoming wave from the body of water, and
a second region which extends from the opening, and which is arranged in use to extend above the surface level of the body of water, the second region for receiving water from the incoming wave after it flows through the opening, such that the oscillating water column is established in use within the housing as a result of repeated movements of water in and out thereof, the flows of water out of the opening being in a direction opposite to the direction of the incoming waves;
and wherein the apparatus further comprises a control system, capable of continuously adjusting one or more functional features of the said apparatus to the extent that a frequency of incoming and outgoing water flows in the, or where there are a plurality of each of them, each oscillating water column(s) substantially corresponds to a respective frequency of the incoming and outgoing waves in the body of water, to thereby optimise the efficiency of conversion of wave energy by the apparatus.

Also disclosed herein, the method comprises the further step of arranging a control system capable of continuously adjusting one or more functional features of the said apparatus, to the extent that a frequency of incoming and outgoing water flows in the or each oscillating water column(s) substantially corresponds to a respective frequency of the incoming and outgoing waves in the body of water, to thereby optimise the efficiency or the extent of conversion of wave energy by the apparatus.

Also disclosed herein, the adjustable functional features include at least one of:
arranging the floatable support structure to be ballasted in use to a degree which maximises its submerged draught or depth relative to the waterline, by controlling the use of a pump to introduce a water flow into, or to withdraw a water flow from, one or more storage tanks located on board the floatable support structure; and/or
arranging the selection and deployment of at least some of the oscillating water columns on the floatable support structure from an available array of oscillating water columns of different respective internal dimensions and thus different natural resonant frequencies; and/or
arranging the selection and deployment of some or all of the available oscillating water columns on the floatable support structure, with adjustment of an available open cross-sectional area of their respective opening(s) using a flow control device which is in direct fluid communication with each opening.

Also disclosed herein, are embodiments of a method of controlling the frequency of movement of water in an oscillating water column when said apparatus is placed in fluid communication with a body of water with waves in use, the method comprising the steps of:
arranging a housing for receiving the oscillating water column, the housing comprising:
a first region arranged in use to be submerged below the surface level of the body of water in which it is located, having an opening arranged for receiving the incoming wave from the body of water, and
a second region which extends from the opening and which is arranged in use to extend above the surface level of the body of water, the second region for receiving water from the incoming wave after it flows through the opening,
such that the oscillating water column is established in use within the housing as a result of repeated movement of water in and out thereof, the flows of water out of the opening being in a direction opposite to the direction of the incoming waves; and
arranging a control system capable of continuously adjusting one or more functional features of the said apparatus, to the extent that a frequency of incoming and outgoing water flows in the, or where there are a plurality of each of them, each oscillating water column(s) substantially corresponds to a respective frequency of the incoming and outgoing waves in the body of water, to thereby optimise the efficiency of conversion of wave energy by the apparatus.

Also disclosed herein, are embodiments of a method for optimising the operation of an oscillating water column energy capture device at an offshore location in a body of water, the method including the steps of:
selecting an energy extraction apparatus for extracting energy from an oscillating working fluid, in accordance with the first aspect;
moving the operably floatable support structure of said energy extraction apparatus to a pre-determined location on a suitable body of water;
anchoring and/or tethering said floatable support structure at said predetermined location; and then
following the steps of the method of extracting energy of the third aspect, for initiating the generation of electric power, and for continuously adjusting the functional features of the apparatus using the control system to improve the efficiency of the power extraction.

Also disclosed herein, are embodiments of a method of controlling the frequency of movement of water in an oscillating water column when said oscillating water column is placed in fluid communication with a body of water with waves in use, the method comprising the steps of:
selecting a housing which is suitable for use in receiving the oscillating water column in accordance with the second aspect;
locating an operably floatable support structure, and installing the housing thereon;
moving the operably floatable support structure and housing apparatus to a pre-determined location on a suitable body of water with waves;
anchoring and/or tethering the floatable support structure at said predetermined location; and then
establishing an oscillating water column in the housing as a result of repeated movement of water in and out thereof, where the movement of water out of the housing is in an opposite direction to the movement of incoming water from the body of water with waves, and using a control system as defined in the fourth aspect, to continuously adjust the functional features of the apparatus, so that the frequency of movement of water out of the housing more closely corresponds to the frequency of movement of incoming water from the body of water with waves.

Aspects, features, and advantages of this disclosure will become apparent from the following detailed description when taken in conjunction with the accompanying drawings, which are a part of this disclosure and which illustrate, by way of example, principles of any inventions disclosed.

### DESCRIPTION OF THE FIGURES

The accompanying drawings facilitate an understanding of the various embodiments which will be described:

FIGS. 1A and 1B are schematic, perspective and other views of an embodiment of a floatable support structure in the form of two cargo ships 120 suitable as a base for positioning a support platform 130 therebetween to form a catamaran type of structure, with the vessels and the skeleton holding structure 140 that is under the platform suitable for mounting a number of OWC housings 50, in accordance with the present disclosure. In practice such vessel cannot move under its own power, but will sit steady in the water, once it has been tethered or anchored in such a way as to create a “near” to horizontal non-moving structure in wave and swell conditions. The mooring of such a vessel and structure shown in these drawings is such that the vessel will be pivoted rotationally, so that its elongate axis is aligned orthogonal with the direction of the crests of the approaching wave fronts. The underside of the vessel at the location of the moonpool retaining openings is continuously submerged. Having these openings 50 in a position at or near the bottom of the two hulls 120, and suspended between the two hulls, puts these OWC chambers out of sight, and leaves the two vessel top platforms and the adjoining platform 130 free for installation of an industrial process using power, for example. A ship in this orientation, and depth location relative to the waterline is in an ideal condition to harness energy from waves.

FIGS. 1C ((a) side view; (b) plan view; (c) perspective view); and FIGS. 1E, 1F and 1G (schematic side and plan views) are schematic side and top views of an embodiment of two or three OWC housings 50, showing the details of the airflow movements in and out of the internal flow passage and the actions of the downstroke and upstroke turbines.

FIG. 2 is a schematic, side elevational view of an embodiment of an apparatus for extracting energy from the wave swell of a body of water by using an oscillating water column in accordance with the present disclosure, the apparatus comprising a floatable support structure in the form of a ship which is fitted with an array of spaced-apart, vertically oriented, elongate chambers which protrude from the upper body of the ship, each of which are connected to the body of water via a moonpool chamber opening in a hull of the ship below the waterline, and within which an oscillating water column is generated during use. The motion of the oscillating water column influences the movement of an oscillating working flow of air being received into, and discharged from, an internal flow passage, which is located inside an upper region of each elongate chamber. An energy conversion unit, including a rotatable air turbine, is in fluid connection to at least one of those air flow(s) in or out of each internal flow passage.

FIG. 3 is a front, perspective, schematic view of the embodiment of an apparatus for extracting energy from the wave swell of a body of water by using an oscillating water column, in accordance with FIG. 2.

FIG. 4 is a schematic, vertically cross-sectioned, end elevational view of the embodiment of an apparatus for extracting energy from the wave swell of a body of water by using an oscillating water column, in accordance with FIG. 2 and FIG. 3, further illustrating a series of individual, stacked ballast tanks on board the floatable support structure which in use can be filled or emptied, respectively so as to cause the vertical position of the floatable support structure to become relatively lowered into, or relatively raised out of, the body of water.

FIG. 5 is a schematic, vertically cross-sectioned, end elevational view of a partial embodiment of an apparatus for extracting energy from the wave swell of a body of water by using an oscillating water column in accordance with the present disclosure, the Figure showing a moonpool chamber or cavity which is located in the hull of a floatable support structure (for example, in a ship), or at the base of a floatable structure (for example, a semi-submersible platform), further illustrating how most of the moonpool chamber shown is located above the waterline in one position; additionally the directions of the arrow indicate how during use: (i) movement of the wave swell relative to a tethered vessel and/or (ii) lowering the position of the floatable support structure relative to the waterline, both can generate an oscillating water column in the moonpool chamber and within an oscillating water column (not shown) located thereabove.

FIG. 6 is a schematic, side elevational view of an embodiment of an apparatus for extracting energy from the wave swell of a body of water using an oscillating water column in accordance with the present disclosure, the apparatus comprising an array of spaced-apart, vertically oriented, elongate chambers which protrude from the upper body of a floatable support structure (not shown), each of which are connected at their lower end to the body of water via a moonpool chamber opening located in a lower region of the floatable support structure (not shown) below the waterline (shown as a curved wave line), and within which an oscillating water column is generated during use. The motion of the oscillating water column influences the movement of an oscillating working flow of air being received into, and discharged from, an internal flow passage, which is located inside an upper region of each elongate chamber. An energy conversion unit, including a rotatable air turbine, is in fluid connection to at least one of those air flow(s) in or out of each internal flow passage, and each rotor of the turbine is connected to an alternator and a generator to produce electricity.

FIG. 7 is a schematic, cross-sectional, side elevational view of an embodiment of an apparatus for extracting energy from the wave swell of a body of water using an oscillating water column in accordance with the present disclosure, the apparatus viewed along a vertical, axial cross-sectional plane, in which the lowermost vertical arrow depicts the direction of undulatory wave motion forming an oscillating water column in the lower part of the open chamber (moonpool) located on the front side of the apparatus where the waves are incident (shown as coming from the left hand side of drawing). This sketch shows the Max WL and Min WL (maximum and minimum waterline levels) which will are important parameters to be aware of to the capture maximum energy of the wave, as these parameters determine the position of the moonpool opening at the chosen location. In the region above the oscillating water column which forms an internal flow passage, the upper vertical arrow depicts the flows of an oscillating working gas which is both displaced from, and drawn into, the internal flow passage via an energy conversion unit in the form of a bidirectional rotatable turbine, thereby demonstrating how movement of the rotatable turbine is responsive to the motion of the incident waves. The floatable support structure shown includes a submersible floating platform on which the apparatus is seated, and which is anchored or tethered to the sea floor by conventional flexible mooring lines which position the floating platform at the ideal water depth between the Max WL and Min WL for the OWC to work.

FIG. 8 is a front, perspective, schematic view of an embodiment of an apparatus for extracting energy from the wave swell of a body of water by using an oscillating water column in accordance with the present disclosure, the apparatus comprising three equivalent and separate units of the OWC apparatus as described in detail hereinbelow in relation to FIG. 9, each of them arranged side by side and facing in the same direction on a floatable support structure in the form of a partly-submersible floating platform, which is anchored or tethered to the sea floor by conventional flexible mooring lines, which position the floating platform and the open mouths of the respective OWC at a pre-selected water draught.

FIG. 9 is a schematic, side elevational view of the embodiment of an apparatus for extracting energy from the wave swell of a body of water by using an oscillating water column in accordance with FIG. 8, in which a wave moves through the OWC apparatus (moving from right to left on the page) via the open mouth, and as a result gas located in an internal flow passage is displaced and flows out of some fluid control device(s) (being one-way valves). When the oscillating wave moves in the opposite direction (moving from left to right on the page) and back out the apparatus towards the body of water, the one-way valves are forced closed, and gas is drawn in a flow through a unidirectional turbine, (causing it to turn the turbine and to generate electrical energy), and flow back into the internal flow passage, until the wave front returns and so the cycle is repeated. The OWC apparatus is seated on a floatable support structure in the form of a partly-submersible floating platform, which is anchored or tethered to the sea floor by conventional flexible mooring lines which position the floating platform at a pre-selected water draught.

FIG. 10 is a schematic, cross-sectional, side elevational view of an embodiment of an apparatus for extracting energy from the wave swell of a body of water using an oscillating water column, in accordance with the present disclosure, the apparatus viewed along a vertical, axial, cross-sectional plane. The floatable support structure is shown with an arrangement of conventional mooring lines to tether it to the sea floor, at a pre-selected water draught. The vertical up and down arrows depict the direction of undulatory wave motion which forms an oscillating water column in the lower part of the open chamber (or moonpool, located at the centre of the apparatus shown), which is accessed by the waves from the front side of the apparatus where the waves are incident (right hand side of drawing). The upper end of the open chamber comprises a more narrowly tapered region, forming an internal flow passage located above the oscillating water column, in which the movement of water is measured by a sensor detection system, which guides a continuous adjustment of the vertical draught of the wave moonpool opening to optimise the absorption of wave energy.

FIG. 11 is a schematic, side elevation view of the embodiment of an apparatus comprising a floatable support structure in the form of a ship, arranged for extracting energy from the wave swell of a body of water by using oscillating water columns, in accordance with FIG. 2, and where the floatable support structure is shown utilising a turret mooring arrangement of conventional mooring lines to tether it to the sea floor, and at a pre-selected water draught. In this and other illustrated mooring arrangements, the floatable support structure, is tethered or anchored so as to create a “near” to non-vertical moving structure in wave and swell conditions, but still with sufficient flexibility to respond to changes in buoyancy created by ballasting.

FIG. 12 is a top plan, schematic view of the embodiment of an apparatus comprising a floatable support structure in the form of a ship, arranged for extracting energy from the wave swell of a body of water by using an oscillating water columns, in accordance with FIG. 11, and where the floatable support structure is shown utilising a “turret mooring” arrangement of a group of conventional mooring lines positioned near one end of the ship to tether it to the sea floor. Such an arrangement allows the axis of the ship to move and to become orthogonally aligned with the direction of propagation of the waves, indicated by the arrow. Such a mooring technique is typically used in deeper water applications where greater flexibility of horizonal movement is permissible.

FIG. 13 is a top plan, schematic view of the embodiment of an apparatus comprising a floatable support structure in the form of a ship, arranged for extracting energy from the wave swell of a body of water by using an oscillating water column, in accordance with FIG. 2, but where the floatable support structure is shown utilising a “spread mooring” arrangement using two groups of conventional mooring lines near opposing ends of the ship to tether it to the sea floor, and at a pre-selected water draught. Such an arrangement confines the ability of the ship to move around in a horizonal plane. Spread moorings are typically used for shallower water mooring of ships. In this and other illustrated mooring arrangements, the floatable support structure, is tethered or anchored so as to create a “near” to non-vertical moving structure in wave and swell conditions, but still with sufficient flexibility to respond to changes in buoyancy created by ballasting.

FIG. 14 is a schematic, side elevational view of a prior art offshore hydrogen and oxygen production facility which is set up on a floating support structure on a body of water, from which the process takes its feedwater and firstly subjects it to purification/de-ionisation to remove contaminants, and then the process of electrolysis to produce hydrogen and oxygen gases, which are compressed and then pressure stored for later on-shore use. The facility is powered by on-shore wind turbine electricity.

FIG. 15 is a schematic, side elevation view of an apparatus comprising a floatable support structure in the form of a ship, arranged for extracting energy from the wave swell of a body of water by using oscillating water columns, in accordance with FIG. 2, and where the floatable support structure is shown utilising the electricity which it generates from the motion of the waves when tethered or anchored in the ocean, to power the operation of an offshore hydrogen and oxygen production facility which includes the same process steps of water purification/de-ionisation, electrolysis, gas compression and then storage for later on-shore use as depicted in FIG. 14. The facility may also combine the use of additional energy sources such as solar panel and wind turbine electricity generation.

### DETAILED DESCRIPTION

### General Introduction

Previously known apparatus for the capture of energy from wave motion using oscillating water column technology has usually been in relation to structures placed as fixtures to the seabed, on open coasts, or built into breakwater walls. To increase the operational envelope to capture wave energy from the oceans, coastlines with accessible deep waters, and other deep water such as river estuaries, the present disclosure uses an application of OWC technology which is located in deep water, and anchored or tethered to the seabed, where the apparatus is constructed on a partially submersible, floatable support structure (eg ship, barge, base platform) to maintain the apparatus in a relatively fixed position, as well as being oriented to face in the direction of prevailing waves of highest energy.

This disclosure relates to the features of an apparatus for extracting energy from an oscillating working fluid, for example ocean waves repeatedly entering and leaving the apparatus in use. The disclosure also relates to the features of the apparatus which can assist to maximise the capture of the incoming waves. The disclosure also relates to a method of operating and controlling the apparatus to maximise the quantity of energy generated. The apparatus has a design which enables greater energy generation per unit flow of fluid than other known techniques in this field.

The present disclosure can extract energy from ocean wave swell motion, using an OWC where the entry chamber is in the form of a moon pool which is built into a carrying structure, such as a floating vessel (including converted ships, floating oil production platforms, barges and the like). The moonpool entry chamber is constructed to be in fluid connection with a further elongate chamber which rises up through the floating vessel to a height above sea level.

### The Structure

The floatable support structure itself may be anchored or tethered to the ocean floor and held in a relatively fixed position, and/or arranged to be in a ballasted and balanced condition, and positioned by buoyancy to be sitting relatively low in relation to the surrounding water, when compared with the usual position of a floating vessel when in motion. This position can ensure that an optimal capture of the energy from the wave swells can occur, and also that the vessel itself can be positionable into an optimal orientation so as to have its side facing into the direction of incoming wave trains.

In a converted ship, such as a converted barge or bulk carrier, each with lots of empty interior spaces, a plurality of hull openings (in the form of moonpool chambers) and their respective interconnected elongate chambers can be retrofitted in one or more rows located adjacent to the opposing side walls, and generally spaced down the length of the ship. Any arrangement of such devices in rows or other suitable arrays is possible, if securely housed.

Surrounding those approximately vertical (or even angled) elongate chambers is also an arrangement of ballast tanks which can also be retrofitted to the ship and arranged evenly over its length, so that the effect of ballasting can also occur evenly. The purpose of having additional ballast tanks is for the floating vessel to be able to take on more water when it has been securely anchored or tethered, and is no longer in a state of driven motion across the sea or ocean. Ballasting will cause the floating vessel, to be able to assume a lower position in the water.

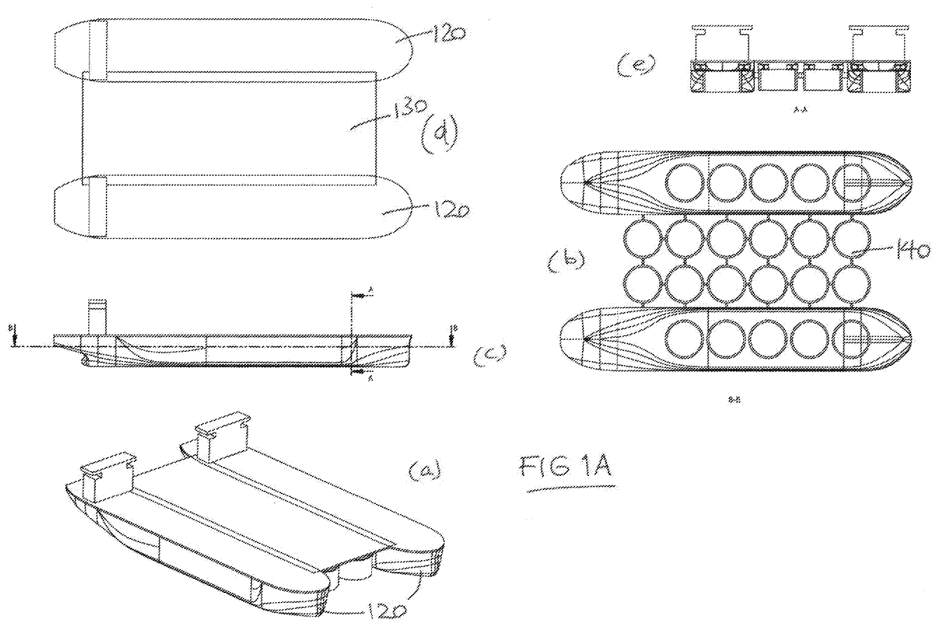

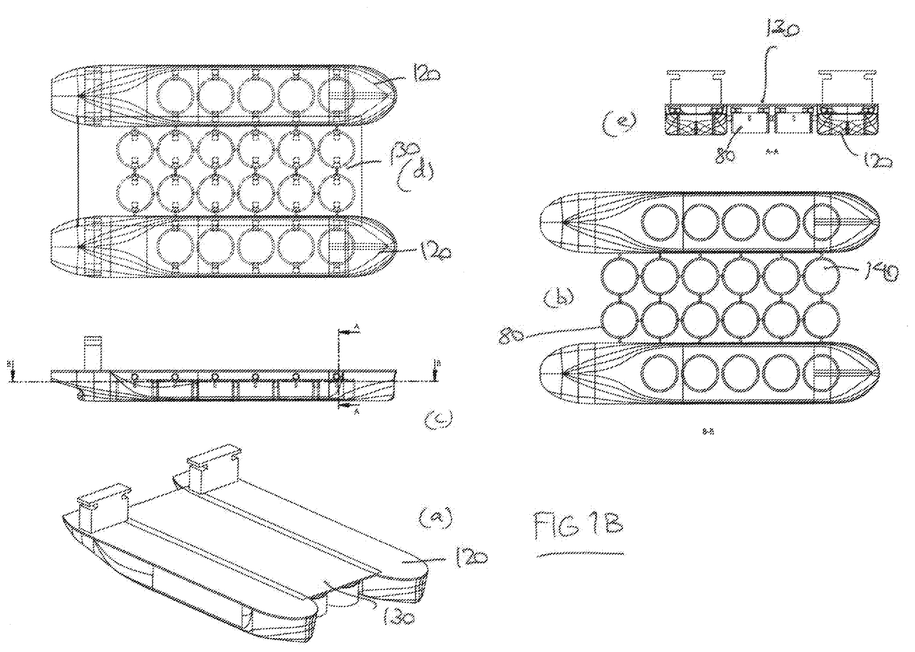

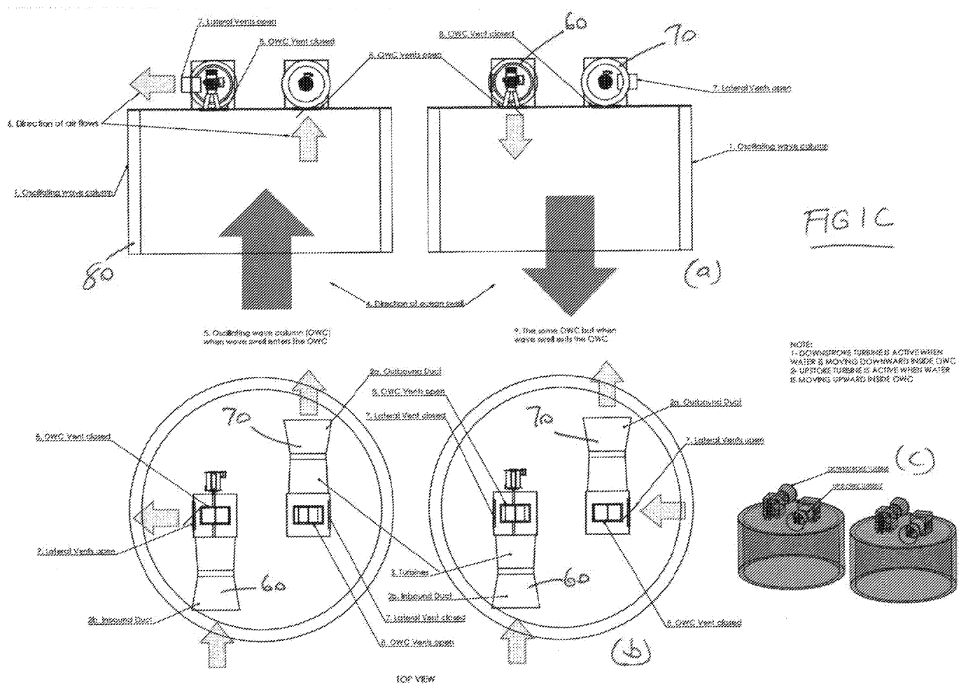

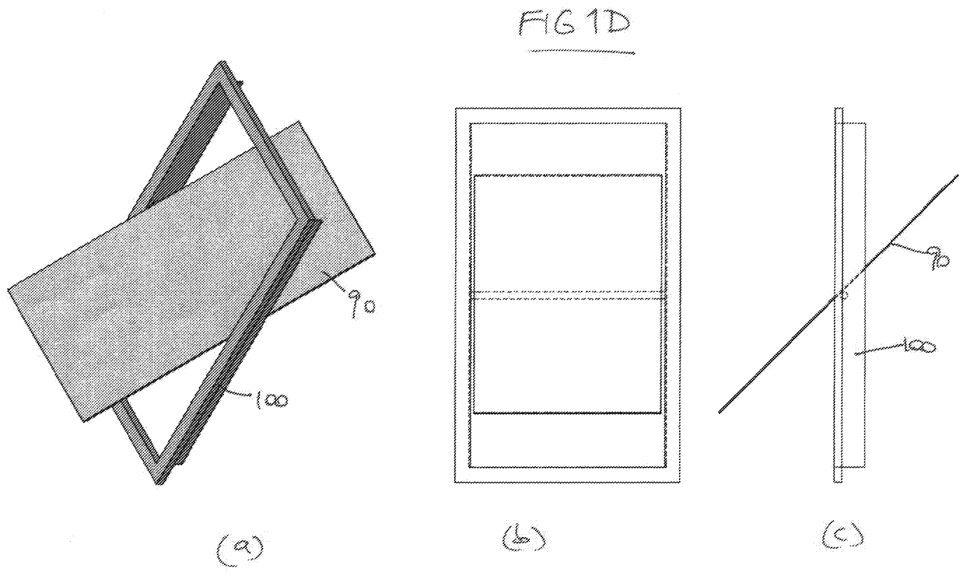

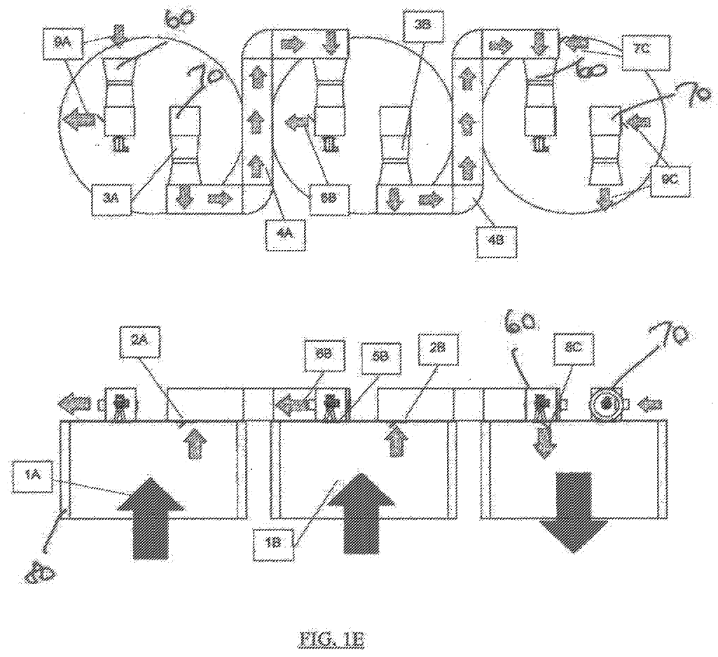

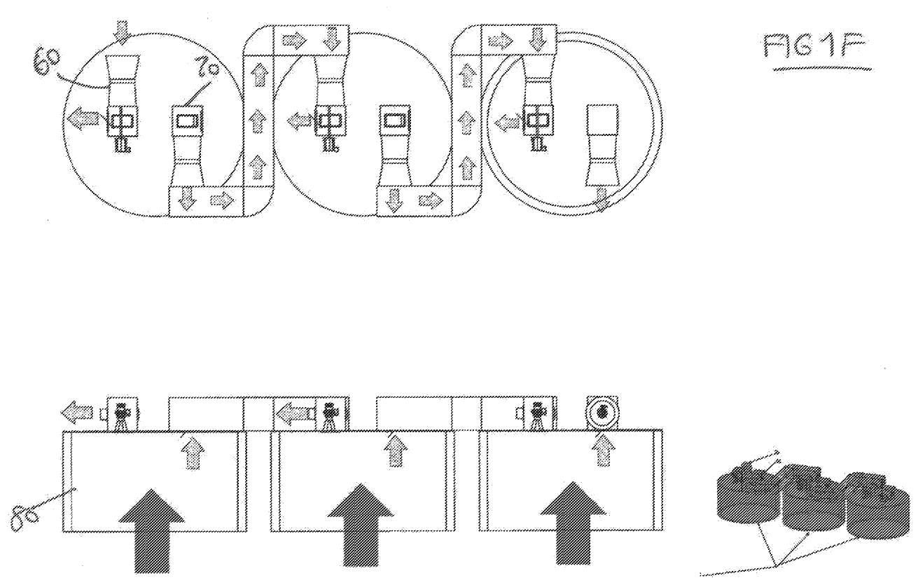

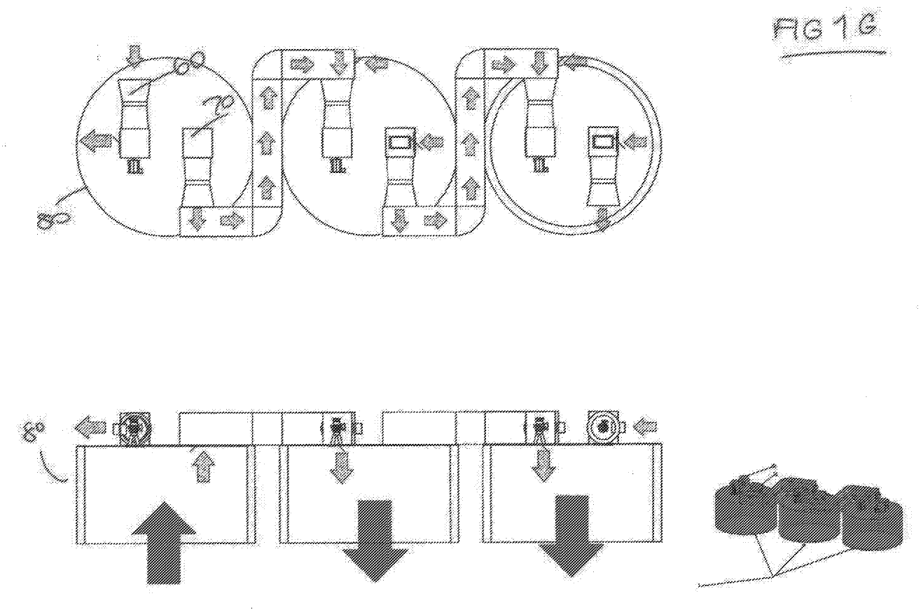

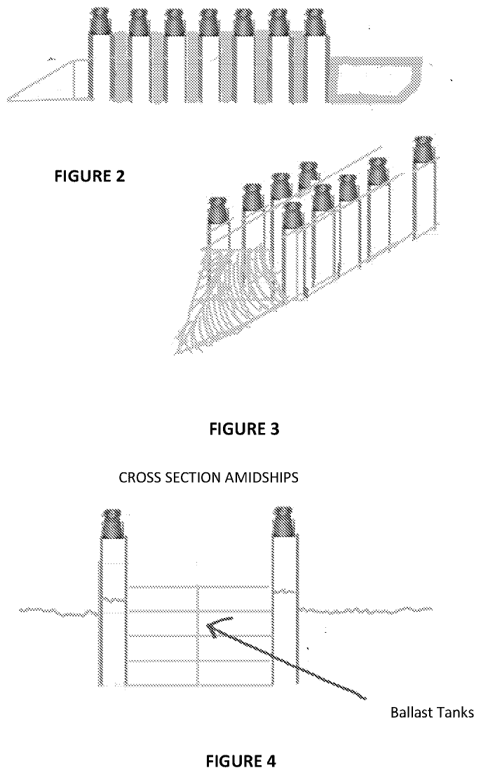

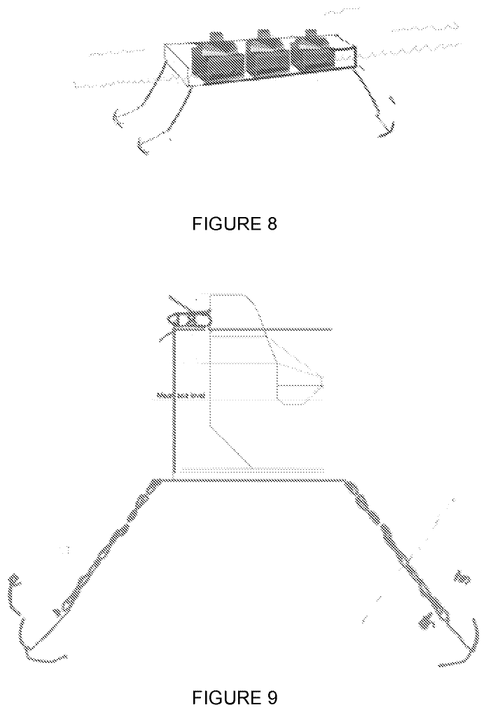

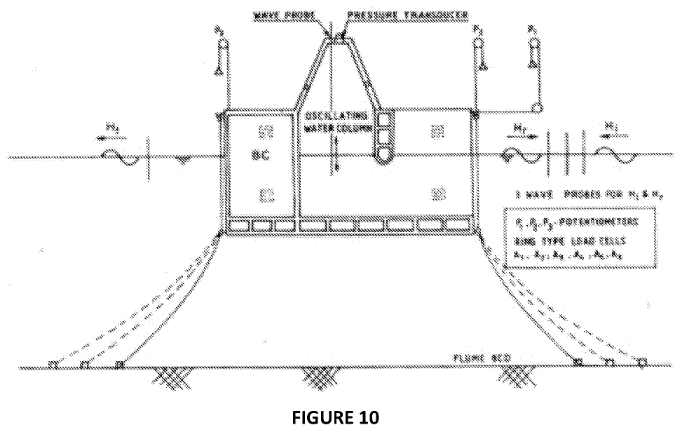

Reference can be made to FIG. 4 showing layers of ballast tanks across the width of the ship. Reference can be made to FIGS. 1A-1B, 2, 3 and FIG. 15 for various examples of a floatable support structure in the form of a ship, and FIGS. 8, 9 and 10 for other types of floatable support structures or structures, seated on platforms.

### Launch, Positioning and Tethering

In a non-submerged state, the ship or barge moveable towards the pre-determined destination by towing, and then for in-water positioning and tethering, the OWC chamber and associated apparatus having already been fitted thereinto. Once the ship is in its desired final operational position, and in the chosen alignment with the prevailing wave climate, it can be tethered appropriately and then ballasted so that it remains partially submerged in its final position in the water, where it will capture waves and generate energy. It is noted that automatic adjustments to optimise the ballast draught condition for maximum efficiency of wave energy conversion during use are likely, but such monitoring can be conducted remotely.

The ship can be anchored or fixed to the seabed depending on the environmental and sea state conditions expected at the installation site. The overall apparatus requires the use of a suitable and a safe fixture onto the seabed, since its location is normally going to be in a deep sea water environment. In situations other than a directly tethered or anchored vessel such as a ship, other exemplary arrangements include a connection from the floatable support structure to a support structure which, in turn, is itself connected by tension stags to a gravity anchor.

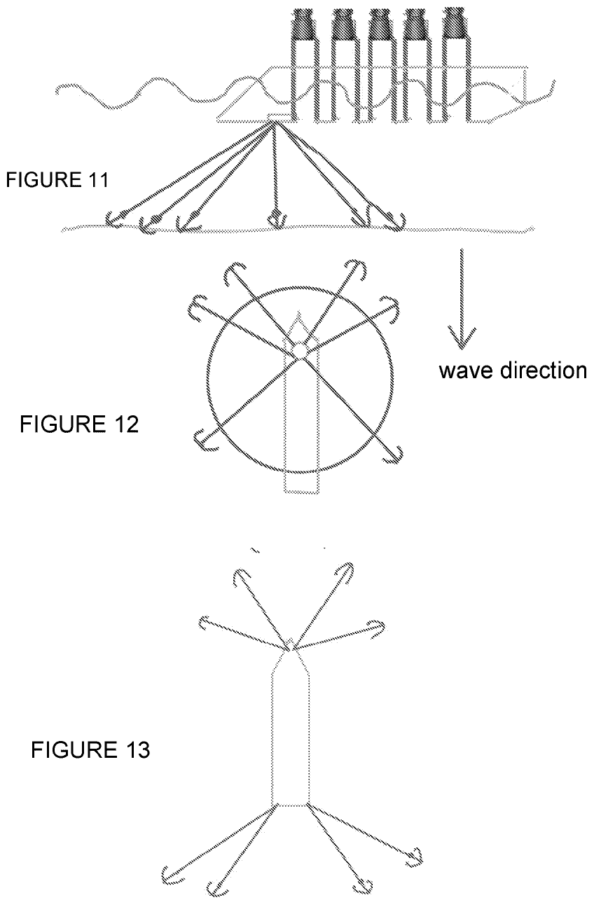

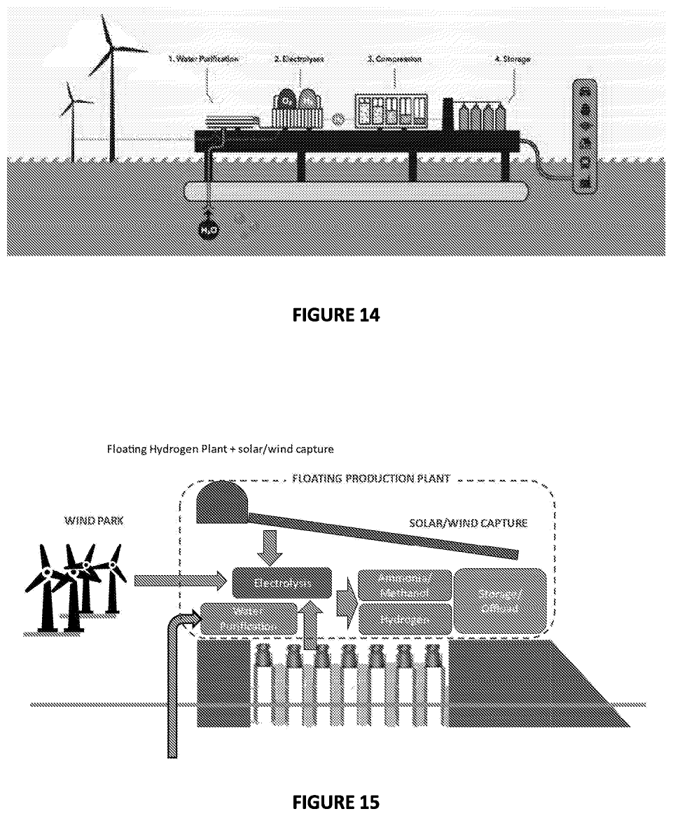

Reference can be made to FIGS. 8, 9 and 10 for examples of buoyant apparatus tethering methods, and to FIGS. 11, 12 and 13 for examples of ship tethering methods.

### The Opening—A Moon Pool Chamber

A moon pool is a known feature of marine drilling platforms, drill ships, diving support vessels and underwater exploration vessels, in which it is also known as a “wet porch”. It is an opening cavity in the floor, or base, of the hull of the ship or platform, which provides access from the interior of the ship to the water below, allowing people or equipment to be lowered into the ocean. A moonpool chamber provides shelter and climate protection so that, even if the ship is in high seas or surrounded by ice, those operation to access the water underneath the ship can continue. Operators can work in, or dive from, the moonpool chamber the instead of attempting to work on an upper deck of the ship, and be exposed to the elements.

Because the moon pool chamber lies below the waterline level at which the ship is floating, it is effectively an airtight or pressurised chamber in the bottom of the ship or floating structure. The chamber is located below sea level, so consequently its design requires consideration of both the air atmospheric pressure therewithin, and the water hydrostatic pressure at that chamber depth, which counteract one another at the water level surface within the moon pool. The atmospheric pressure is maintained under control in the moonpool chamber, to a level which is greater than the hydrostatic pressure, which is attempting to cause seawater to rise up into the moonpool chamber, (or higher).

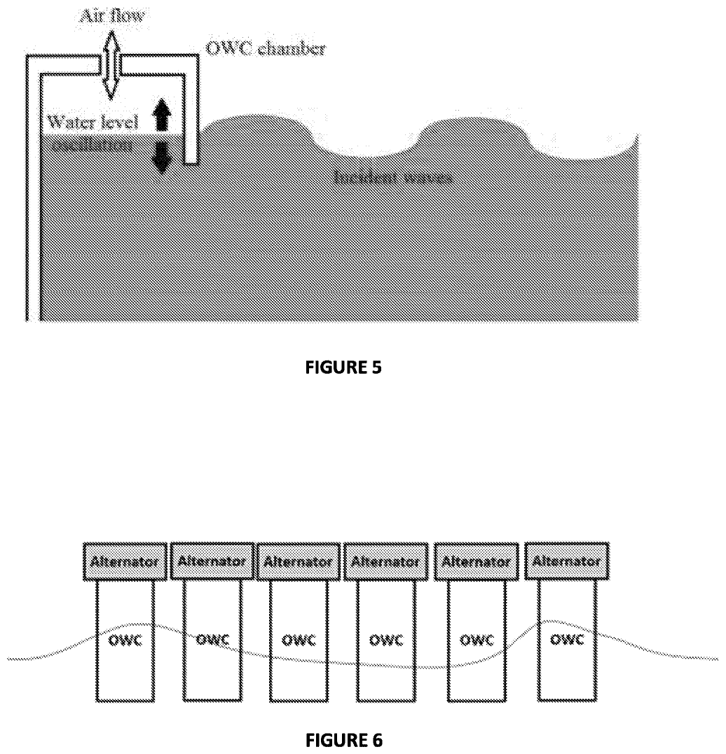

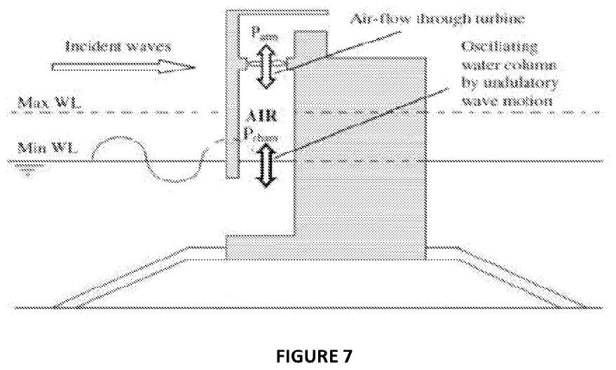

As shown in FIG. 5 and FIG. 7, in the present disclosure, exemplary moonpool opening chambers are arranged along the lower underside flank of both sides of the hull of the ship, being a region which is substantially submerged, and well below the below the mean surface level (MSL) of a body of water in which it is located (the average waterline) when the ship is in normal use (“normal use” being defined as excluding those times when the ship is in dry dock, or in high seas in a storm, or capsized, and when the underside of the hull is likely to be exposed).

The moonpools are shown in those Figures as a cavity, or a small chamber within the hull of the ship. The outermost framed entry mouth of the moonpool chamber sits flush with the surrounding material of the hull surface, defining a hole formed in and framed by the surrounding hull surface, being the opening via which water can enter and leave the moonpool during use.

Each system comprises one or more moon pool chambers that are each arranged to allow ocean waves to enter them horizontally. The moon pool extends vertically into an elongate chamber via a closeable access hole. The vertical chambers or OWC chambers are located within the hull extending upwards from the lower area of the ship. The moon pool chambers are arranged lengthwise down the sides of the ship structure, in two rows or arrays, as shown in FIG. 3, for example. These openings are of a form/shape that does not seek to obstruct, but to enable maximum water entry and exit into the OWC chamber to form a water column, and hence create the required vacuum to propel an air turbine, which in turn runs a generator to produce electricity.

### The OWC Chamber

### Moonpool-Style of Chamber in a Vessel Hull

Referring to the drawings, the exemplary apparatus shown in any of FIGS. 5, 7 and 10, for example, comprises an opening in the form of a moonpool chamber, and an upright, elongate chamber which is connected to and extending generally upwardly therefrom.

Examples of self-moving vessels include motorised ships, larger-sized boats, tankers, freighters or other hulled vessels such as twin-hulled catamarans (which have a platform positioned between parallel boat hulls), all of which are at least partly submersible in the body of water in normal operational use.

In certain embodiments, the floatable support structure comprises a platform attached to two or more buoyant vessels which retain the platform above the level of the body of water having waves, the platform and optionally the vessel(s) being arranged to support a plurality of the housings in position so that, when deployed, each housing is configured to contain an oscillating water column which is arranged to be in fluid communication with both the body of water, via a respective opening of the housing, and with an internal flow passage located in the housing.

The oscillating water column (“OWC”) chamber, or elongate chamber, is shown as being located adjacent to, and above the moonpool chamber in some embodiments. The moonpool chamber can be placed in fluid communication with the elongate chamber by opening a closeable access hole, which separates these two chambers. The closure mechanism can, for example, be located at an innermost, upper surface of the interior wall which defines the moonpool chamber. During operation of the oscillating wave chamber, the closure will be partially (or completely) retracted/opened to an extent which is operably sufficient to allow water to flow in and through the moonpool chamber and then into the elongate chamber.

The moonpool chamber is also where a closure operating system or mechanism will be present, to enable the closure to be opened or closed, to any extent, and continuously adjusted by automation, depending upon measured prevailing ocean conditions.

An OWC can be established from the rise and fall of the wave swell of the water body surrounding the ship, with that water repeatedly passing upwardly into and through the moonpool chamber and then upwardly and into the elongate chamber on the upstroke of the wave to form a rising column of water. Subsequently on the downstroke of the wave, under suction pressure the said water column flows downwardly out of the elongate chamber and then flows downwardly through the moonpool chamber and back out into the surrounding water body.

The elongate chamber itself extends from the moonpool chamber and is oriented upwardly into the body of the ship, towards the uppermost surface or deck area, which is normally positioned above the waterline in use. Typically, the elongate chamber is cylindrical in its cross-sectional (possibly having a round cross-sectional shape, but square, rectangular or other shapes are also possible), and the inner surface is of smooth material to minimise frictional losses as water repeatedly flows up and down. A typical construction material can be stainless steel pipe, but hard plastics or other cast materials can also work.

Interaction with a Uni-Directional Flow Turbine

Referring to the drawings, the exemplary apparatus shown in any of FIGS. 1E, 1F and 1G, for example, comprises an opening in the form of a moonpool chamber, and an upright, elongate chamber which is connected to and extending generally upwardly therefrom.

In use, as an ocean wave enters a moon pool cavity, the water then moves vertically, filling at least part of the vertical chamber, and displacing at least some of the air which is initially present in that vertical chamber as well as in the internal flow passage. That displaced air flows through a one-way valve, or air baffle valve, until an the equilibrium point is reached with the outside air pressure, when the air baffle valve closes automatically by gravity, sealing off the internal flow passage.

Then, as the wave moves into the suction/receding part of its cycle, the vertical OWC recedes downwardly in the elongate chamber and out through the moon pool chamber opening, the effect of this downward escape stroke of the OWC creating a substantial air vacuum in the internal flow passage and the elongate chamber above the moon pool. This vacuum is relieved by air passing through a suitably sized pipe or similar housing structure for the turbine which is located on top of, and connected to, the internal flow passage, and via which a flow of air is drawn into the internal flow passage, to drives the rotation of a high efficiency air turbine mounted within that turbine housing structure.

For a uni-directional turbine arrangement, the uppermost end region of the elongate chamber defines the internal flow passage, which is fitted with one or more one-way baffle-valves that allow any built-up air pressure in the internal flow passage to escape to atmosphere, until the point where the pressure of that passage drops to be in equilibrium with the atmospheric pressure outside.

In yet other embodiments, the valves are fitted with a control mechanism to control their opened and closed configurations. For example, the valve may have a gate which can be opened and closed to the flow of gas by a hinged movement, or by a sliding movement or by a rotatable movement to at least cover a part of the cross-sectional opening passage of the valve. In yet other embodiments, the valves used can be configured in any other appropriate orientation to respond to changes in the pressure and/or direction of flow of the oscillating air entering and leaving the flow passage.

Importantly, because the access to the displaced gas in the flow passage in the uppermost region of the elongate chamber can be via one or more valves (or other forms of flow control devices) as well as via the unidirectional turbine, it is possible for the system to be configured to operate the valves, and the turbine, to give access to the flow chamber separately, and sequentially, to one other. By doing so, this means that the design of the turbine can be unidirectional only, which is considerably simpler than the arrangements in known oscillating water columns for power generation, which have previously necessitated using a bi-directional air flow turbine which rotates unidirectionally on a shaft.

In yet other arrangements disclosed herein, the flow situations described above are reversed, so that when the wave moves into the OWC chamber, the air in the internal flow passage in the uppermost region is displaced by the rising water pressure in the duct to flow out via a unidirectional turbine, so as to be discharged to the atmosphere. In such an arrangement, in the reverse cycle when the wave moves out of the elongate chamber via the mouth and back towards the body of water, atmospheric air is then drawn back into the internal flow passage via valves, which are arranged to be comparatively more easily opened in the one direction into the internal flow passage than if the air flow could have been passed into the internal flow passage through a unidirectional turbine. It is established that the efficiency of such an arrangement is significantly less than able to be achieved by the flow situations in the reverse configuration.

### Turbine Design and the Electric Generator

In the case of a unidirectional flow system, the turbine can be of a basic known design, including a rotor comprising a central hub located on one end of a rotatable shaft, and a plurality of blades arranged about and extending from the periphery of the hub, the rotor being disposed within a housing in fluid connection with the flow passage. The shape of the turbine blades and their orientation in relation to the hub facilitates unidirectional rotation of the turbine rotor in response to a unidirectional axial flow of gas through the turbine housing.

As is typical in turbines of this type, an electric generator is configured for rotation by the turbine to generate electrical energy, by being connected to the end of a drive shaft of the turbine, at the opposite end of the drive shaft to the location of the central hub. The wave energy capture system is entirely mechanically passive in operation and control of the generated electricity output is obtained solely by an electronic control system that can be remotely monitored. The electrical control and capacity and battery systems are contained in water sealed compartments.

The turbine-generated electricity is fed through high power capacitors and/or battery packs that are present to “level out” peaks in the generated power stream, and to deliver steady, fully levelled-out current output from the system to a cable connected electricity network grid, or alternatively as pulsing powertrains which are levelled out at the receiving end, but before entered into the final network grid.

Using the oscillation water column technology in open ocean waters in an upscaled version of the present disclosure can produce substantial green renewable energy that can be safely and cost-effective fed into electrical grids. Otherwise, the power which is generated can be used by a facility located on board the ship or barge. Referring to FIG. 15, the electricity generates by the apparatus shown is used to power the operation of an offshore hydrogen and oxygen production facility which includes the process steps of water purification/de-ionisation, electrolysis, gas compression to yield a product for later on-shore use.

### Maximising the Efficiency of Energy Transfer

If the frequency of the oscillating water column which flows into and out of the apparatus substantially corresponds to the frequency of the incoming and outgoing waves from the body of water, then the operation of the present energy extraction apparatus will be smoother and more efficient, rather than needing to operating in a situation where the oscillating flows in the OWC are constantly out of sequence with the waves, and therefore subjected to extra turbulence and inefficient OWC operation, which then means an inefficient draw of air into the internal flow passage via the turbine.

Such a “tuning” of the frequency of the oscillating water flow in the duct can be performed continuously, depending on the prevailing ocean wave conditions, for example by automating the adjustment of the valve openings by using a control mechanism which is responsive to measured changes in the pressure of incoming and outgoing waves. In such an arrangement, the control mechanism can selectively open or close (or partially open or close) the valve between the moonpool and the vertical chamber. This adjustment can change the available cross-sectional area available for the flow of water up the elongate chamber, and therefore reduce the discharge and subsequent intake via the openings to and from the internal flow passage in the uppermost region of the elongate conduit of the apparatus.

In yet a further example of “tuning” of the frequency of the oscillating water flow in the elongate chamber, if the prevailing ocean wave conditions are dangerous or wild, for example during a storm, the valve control mechanism can be used to close and lock down a sufficient number of the valves between the respective moonpools and their vertical chambers, so that a head of air pressure is maintained within the internal flow passage. Such “de-tuning” can act as a safety feature by excluding the strongest waves from the ocean from reaching as far up into the duct, and in doing so, possibly protecting the valves and turbine from storm damage.

Once the steps below have reached a stable, repeating status of:
opening the valve(s) in the moonpool chamber; and
the wave enters the elongate (OWC) chamber; followed by discharge of air from that chamber; and then
as the wave leaves the OWC chamber and also the moonpool, under suction; so that
the one-way valve(s) to the internal flow passage become closed; and
air is drawn into the turbine chamber via the turbine,
   the turbine will turn the alternator and the generator will generate electrical energy which can be conveyed from the apparatus (located offshore) to the land (on the shore) by means of an insulated high voltage copper cable.

### Turbine Configuration

Referring to FIG. 1C, a two-turbine arrangement fitted to a single housing is shown in two airflow configurations. The upstroke turbine is engaged during the upstroke flow phase of the OWC and is designed with a power generation capacity of 1.1 MW.

The configuration shown includes a narrower inlet which serves to amplify the velocity of incoming air as it encounters the turbine blades. This, in turn, augments the kinetic energy of the airflow. Additionally, the incorporation of an expanded nacelle downstream of the turbine to induce a pressure drop, to encourage increased airflow.

Also referring to FIG. 1C, the other turbine of the two-turbine arrangement fitted to the single housing is the downstroke turbine, also shown in two airflow configurations. This turbine is operational during the downstroke phase, featuring a higher design capacity of 3.44 MW.

The conical shape of the inlet is uniquely conical in shape. This design gives the capacity to supply the airflow volume required by the downward wave movement of the OWC during that suction phase. The conical design optimizes this volume, ensuring a sufficient quantity of air for the turbine's operation. Furthermore, the conical design also contributes to the acceleration of air velocity.

These two turbines provide specific airflow dynamics during the upstroke and downstroke phases. The choices of narrower and conical inlets, along with downstream nacelle expansion, are employed to enhance kinetic energy, increase airflow, and optimize air volume, ultimately leading to greater power generation efficiency.

### One Way Valve Flow System

The one way openings used throughout the various examples of have similar concept and they have a pivot in center and have an extended energy extraction from an OWC edge on one side to prevent the rotation. The opening also could consist of self-closing system. In figure below the opening is shown

### Explaining the Sequences of System.

During the upward motion of a wave (1A) inside the OWC (80), the air in the internal flow passage becomes compressed and its pressure increases. This activates the one-way valve opening (2A), this valve being linked to the upstroke turbine (capacity 1.1 MW). The compressed air then enters the intake (3a) of the turbome.

As the airflow traverses the turbine, it enters a cowling (4a) situated downstream of the upstroke turbine. This cowling is connected to the inlet of the downstroke turbine in the subsequent OWC.

As shown in FIG. 1D, in one of the OWC chambers where water is shown as moving upward, the one-way opening (5B) associated with the downstroke turbine remains closed, since the upward pressure of air pushes it closed. Consequently, the air which is being fed via the conduit (4A) cannot become part of the flow into the chamber via the downstroke turbine, and so the flow exits the system by being directed through a bypass opening (6B) located on the side of the downstroke turbine.

As wave moving upward in middle OWC, the sequences 1a, 2a, 3a & 4a are repeated. As the right OWC, is in suction phase, airflow is directed through the downstroke turbine (3.44 MW). However, there is a possibility that the volume of air within the cowling might be insufficient. In such cases, the one-way opening located at the turbine's inlet (7a) opens, allowing ambient air to be drawn in and supplementing the available air volume. The airflow then passes through the turbine during the suction phase and enters the OWC area (8a).

For the OWCs located at the chain's end, one turbine is not connected to a cowling. These turbines remain active according to their designated sequence (upstroke or downstroke). During their inactive periods, as the turbine continues to rotate at a lower speed, there exists a chance of a lower-velocity airflow within the turbine. Consequently, the specific configuration of baffles and bypass structures, as depicted in the figures below (9a), becomes relevant

As shown in FIG. 1E, there is shown a plan view and a side view of a plurality of similarly-configured OWC housings which each define an internal flow passage and an oscillating water column (the latter is not fully shown, but extends below the chambers shown), along with an energy conversion unit in the form of a turbine which is able to be placed in or out of fluid communication with the internal flow passage during use, depending on the configuration. In the present case, in use the similar OWC housings are arranged adjacent to one another in rows which extend across the width of a floating support structure.

In the configuration shown, the first two adjacent housings in the row are respectively arranged so that when the oscillating working fluid pressure increases in the internal flow passage due to an incoming wave from the oscillating water column, is caused to act on the second energy conversion unit, to generate energy as well as to output a unidirectional flow of the oscillating working fluid;

During the upward motion of an incoming wave inside the first OWC (1A), the oscillating working fluid (air) pressure increases in the internal flow passage. This in turn causes the flow control device in the form of a gate valve (2A) to tilt or to hinge open, because of the pressure differential on both sides thereof.

Opening the gate valve (2A) provides access to the second energy conversion unit in the form of an upstroke turbine (3A) (of power capacity approximately 1.1 MW). The flow of pressurized air is caused to act on the upstroke turbine (3A) by entering into the turbine's intake. The pressurized airflow causes the turbine to turn, and then the air enters and flows along an enclosed conduit (4A) which is situated downstream of the upstroke turbine (3A).

The conduit (4A) is connected to the inlet of the downstroke turbine (5A) located at the subsequent OWC housing.

Meanwhile, in the OWC where water is moving upward, the one-way opening of the downstroke turbine (5a) remains closed. Consequently, the air is directed to exit the system through a bypass opening located on the side of the downstroke turbine (6a), wherein the apparatus further comprises an enclosed conduit which in use conveys the unidirectional flow of oscillating working fluid from the second energy conversion unit to an inlet of an energy conversion unit at an adjacent housing to cause the turbine thereof to rotate prior to discharge venting of the oscillating working fluid.
wherein each adjacent housing in the row is respectively arranged so that when the oscillating working fluid pressure decreases in the internal flow passage due to an outgoing wave from the oscillating water column, the flow of oscillating working fluid which exits the internal flow passage via the flow control device ceases, and only the one flow control device which is configured in use to allow the unidirectional flow of said oscillating working fluid to enter the internal flow passage via the energy conversion unit is open.
is caused to act on the second energy conversion unit, to generate energy as well as to output a unidirectional flow of the oscillating working fluid;
the oscillating water column to flow out of the housing;

An apparatus as claimed in claim 4 or claim 5, comprising at least one flow control device which is configured in use for only the unidirectional flow of said oscillating working fluid to enter the internal flow passage thereby, to act on the energy conversion unit, otherwise closed.

An apparatus as claimed in any one of claim 4 to claim 6, further comprising a second energy conversion unit which is disposed at the housing and which is arranged in use to be in fluid communication with the internal flow passage, wherein as

### SUMMARY

The present disclosure is of an improved, floating apparatus which aims to further the efficiency and commercial viability of using oscillating water columns in ocean wave swells, as a means of converting the movement of those wave swells into captured electrical energy.

In one form the apparatus is ballasted vertically to enhance the effectiveness of the entry of the wave or swell trains into the moon pool cavities, whereby a tuned energy absorption of the wave and swell energy is efficiently achieved, thus maximizing the effectivity of the energy absorption.

The present disclosure enables a further improvement of the efficiency of ocean wave swell energy conversion systems utilizing OWC chambers, which are tuned to a period frequency of the ocean waves being received from the adjacent body of water, by adjusting a range of variables to do with the elongate chambers to match the natural period of the wave trains entering the moon pool chamber and OWC chamber.
As a floating structure, the apparatus can be properly ballasted to a maximized draught for receiving the wave trains at the most efficient direction to recover maximum energy from those wave trains.
A built-in sensor system can change the closeable access hole leading from the moon pool chamber into the elongate chamber for continuous optimization, so as to convert the incoming wave kinetic energy through into potential energy and then into electrical energy, in a maximum efficient manner.
There is an array of moon pool chambers present with very different internal dimensions, and therefore with mutually different natural resonant frequencies. They can be operated so that a selection of those frequencies combined can be made, to tune the apparatus for matching energy waves received from the ocean environment.
In an array of moon pool chambers, individual moon pool chambers can be selected using a tuning arrangement which can continuously adjusts the closeable access hole leading from the moon pool chamber into the elongate chamber, for continuous optimization of the energy absorption of the wave energy.

The present system applies every physical method available to maximise the capture of wave energy by adjusting the functional features of the apparatus, such as by extending the moonpool as deep as practicable, through a combination of having the moonpool located on the base of the vessel and the vessel then being ballasted to maximise the operating draught, and in so doing capture a great percentage of each passing wave.

### EXPERIMENTAL SECTION

As wave crests and troughs pass a conventional OWC, water enters and leaves the chamber through its submerged opening. This water rises and falls inside the chamber, causing the pressure of the air trapped above to oscillate between positive and negative pressure. In some embodiments tested, these pressure fluctuations forced the air to pass through either a uni-directional or a bi-directional turbine at the top of the chamber, in an attempt to stably generate electricity as it does so.

### Experimental Setup

Experiments were performed in the Australian Maritime College's Model Test Basin (MTB) which is 35 m long, 12 m wide and capable of 1 m depth but filled to a depth of 333 mm, equivalent to 10 m depth at prototype full scale. The MTB is fitted with 16 piston type wavemaker paddles at one end and a passive beach at the other. The model was situated at the centre of the MTB 12 m from the wave maker.

The 1:30 scale model was manufactured from plywood with clear acrylic sides to enable visual observation of the internal chamber water level. The Power Take-off (PTO) was simulated using an orifice plate which exhibits a non-linear pressure/flow relationship similar to that of the single stage turbine.

The air chamber differential pressure was monitored with three separate pressure transducers. OWC water surface elevation was monitored by six resistive wave probes. Wave probes were connected to the data acquisition system through a HR Wallingford wave probe signal conditioning box.

Data was acquired at a rate of 200 Hz using a 16 bit National Instruments PCI card (NI PCI-6254) connected to a BNC terminal box. Data recording was trigger by wave paddle motion and was recorded for a duration of 30 seconds for regular waves and 600 seconds (30 minutes) for full scale.

### CONCLUSIONS AND ADVANTAGES

Details of an OWC technology which incorporates several innovations, has been presented. The technology addresses the issue of mismatch of efficiency between an OWC for use with a wave swell in a deep body of water. The rectification system, combined with bespoke geometry modifications, was tested at model scale in both regular and irregular wave conditions. The apparatus disclosed herein has many advantages over previously known OWC technologies.

The installation of multiple OWC onto existing floating structures realises several commercial benefits, including:
a lower initial capex due to the pre-made nature of some of the equipment being used (e.g. repurposed or salvaged ships);
a relatively low cost of modification/construction;
additionally, the inventor also expects a faster rate of construction, given that this is largely a retrofit exercise of specific components onto a basic, large-scale capital component.

Other advantages of installation of an OWC onto floating vessels or structures such as ocean-going ships include the following:
the floatable support structures can travel further offshore, and are locatable operationally, when anchored or tethered, at large water depths. This means that there is access to larger-scale offshore ocean waves which contain much greater levels of wave energy, when compared to the size of waves encountered by seabed- or seashore-mounted OWC located in a depth of 4-10 metres of water, where the waves are substantially smaller in scale;
there are vastly more locations for deployment of the apparatus when it is tethered or anchored far offshore, on the ocean;
a large number of floatable support structures with OWC can be located nearby to one another in those offshore locations. It is anticipated that farms (or arrays) of far offshore wave energy converters can be used.
there will be low visual impact and therefore easier community approval on the basis the units cannot be seen from shore. By contrast, previous examples of OWC have been proposed for installation on coastlines or as part of wharves, levees or breakwalls. In those known examples, a large proportion of the apparatus itself is visible, as it extends 5-10 metres above the waterline. In those prior cases, the generation units will generally be located a short distance away from the shoreline, for example in 10 metres of water depth.
In the prior cases where wave power generation units are installed only a short distance away from the shoreline, for example in 4-10 metres of water depth, the incoming wave and swell trains are often disturbed by the sloping seabed, or backslash from other coastline geographical features, which can scatter the waves, and prevent them transmitting their full energy when entering an OWC chamber on the prior apparatus.
The present device can be mechanically isolated in storm conditions to prevent damage, by shutting off the closure of each moonpool;
Each OWC can be configured with two separate unidirectional flow turbines to maximise the energy recovery achievable, in part because of the use of the least complex and most efficient turbine designs (avoids complex and inefficient bi-directional turbines);
The turbine and the generator are kept above the waterline, meaning there is less maintenance due to water damage or corrosion, and any servicing can be carried out easily;
As a floating structure in use, the floatable support structure provides the significant advantage that it can be tethered so that it can be oriented to receive the flow of waves at the most efficient direction to recover maximum energy from the wave trains. Various types of moorings can be used to achieve this, for example the elongate axis of the vessel may arranged orthogonal with the crests of the wave fronts, so that OWC entry openings located in rows across the width of the vessel are each oriented for simultaneous intake of the vertically upward and downward wave motion of the wave fronts;
The reliability and predictability of deep ocean waves is an advantage over solar and wind power. Wave conditions can be accurately predicted as much as a week in advance.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and “lower”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive. For example, while reference has been made to wave generation from the sea or an ocean, wave generation can also occur from lakes, rivers and tidal pools, all of which are suitable for using the present method and apparatus.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realise yet other embodiments. Further, each independent feature or component of any given assembly may constitute an additional embodiment.

1-33. (canceled)

34. An apparatus for extracting energy from an oscillating working fluid, the apparatus comprising:
a housing which is positioned on a floatable support structure that is arranged in use to float on a body of water having waves, the housing defining an internal flow passage for receiving the oscillating working fluid; and
a first energy conversion unit disposed at the housing, in fluid communication with the oscillating working fluid in the internal flow passage, such that in use a unidirectional flow of said oscillating working fluid acts on the energy conversion unit; and
the housing also being arranged to contain an oscillating water column that is in fluid communication with both the body of water and with the internal flow passage in use, such that:
the oscillating water column is established within the housing as a result of repeated movements of water from respective incoming and outgoing flows of the waves; so that
the unidirectional flow of the oscillating working fluid acting on the energy conversion unit is responsive to, and generated by, only one of said flows of the waves,
wherein said fluid communication between the body of water and the oscillating water column occurs via an opening which is located at a part of the floatable support structure which is continuously submerged below waterline, during normal operational use; and
the apparatus further comprising a second energy conversion unit which is disposed at the housing and which is arranged in use to be in fluid communication with the internal flow passage, wherein as the flow of said oscillating working fluid exits the internal flow passage via the one flow control device, it acts on the second energy conversion unit, which is configured to cooperate therewith.

35. The apparatus as claimed in claim 34, wherein the effect of the unidirectional flow of the oscillating working fluid acting on each energy conversion unit is that the configuration of each energy conversion unit(s) be operably unidirectional.

36. The apparatus as claimed in claim 34, wherein comprising one or more flow control device(s) which is/are disposed at the housing and arranged in use to be in fluid communication with the internal flow passage, for selectively changing the configuration of the internal flow passage between one where the unidirectional flow of the oscillating working fluid acts on the first energy conversion unit, to another configuration in which a flow of said oscillating working fluid bypasses the first energy conversion unit.

37. The apparatus as claimed in claim 36, in which at least one flow control device is configured in use to operate separately and sequentially to the first energy conversion unit, so that:
the unidirectional flow of said oscillating working fluid enters the flow passage and acts on the first energy conversion unit, and then
the flow of said oscillating working fluid exits the flow passage via the one flow control device, and bypasses the first energy conversion unit.

38. The apparatus as claimed in claim 37, wherein the unidirectional flow of the oscillating working fluid acting on the first energy conversion unit is associated in use with a suction pressure in the internal flow passage created by the fall of a passing wave, which causes the oscillating water column to flow out of the housing;
and furthermore, wherein the flow of the oscillating working fluid exiting the internal flow passage via the flow control device is associated with a rise in pressure therein, caused by an incoming wave flowing into the oscillating water column in the housing.

39. The apparatus as claimed in claim 37, comprising at least one flow control device which is configured in use for only the unidirectional flow of said oscillating working fluid to enter the internal flow passage thereby, and to act on the first energy conversion unit, otherwise closed.

40. The apparatus as claimed in claim 36, in which at least one flow control device is configured in use to operate separately and sequentially to the first energy conversion unit so that:
the unidirectional flow of said oscillating working fluid exits the flow passage and acts on the first energy conversion unit, and then
the flow of said oscillating working fluid enters the flow passage via the one flow control device, and bypasses the first energy conversion unit.

41. The apparatus as claimed in claim 40, comprising at least one flow control device which is configured in use for only the unidirectional flow of said oscillating working fluid to exit the internal flow passage thereby, and to act on the first energy conversion unit.

42. The apparatus as claimed in claim 34, wherein the oscillating water column is contained in use within an elongate chamber which depends from the opening.

43. The apparatus as claimed in claim 42, wherein some, or all, of the elongate chamber is located at an interior of, or is defined by, the housing.

44. The apparatus as claimed in claim 42, wherein when the floatable support structure includes a vessel, and the opening is located in a hull of the vessel at an underside surface region thereof, the opening forms a cavity or recess thereinto which faces into the body of water in normal operational use,

45. The apparatus as claimed in claim 44, wherein each energy conversion unit is disposed at a part of the housing where it is arranged to be in fluid communication with the internal flow passage, at a part of the floatable support structure which is continuously above the waterline during normal operational use.

46. The apparatus as claimed in claim 34, wherein the first energy conversion unit includes a turbine comprising a rotor with a central hub and a plurality of blades arranged about and extending from the periphery of the hub, the rotor disposed within a rotor housing in fluid connection with the internal flow passage, whereby the shape of the blades and their orientation in relation to the hub facilitates a unidirectional axial flow of oscillating working fluid through the rotor housing.

47. The apparatus as claimed in claim 34, wherein the oscillating working fluid is air, the flow of which is generated by oscillations of the oscillating water column which is in fluid communication with the internal flow passage, at an interior of the housing.

48. The apparatus as claimed in claim 34, further comprising a locating device for locating the floatable support structure in approximately fixed relation to a predetermined position for its intended operational use, but in such a manner that it can reposition itself, or be repositioned, in relation to a prevailing motion or direction of waves flowing in said body of water.

49. The apparatus as claimed in claim 34, wherein the floatable support structure comprises a platform attached to two or more buoyant vessels which retain the platform above the level of the body of water having waves, the platform and optionally the vessel(s) being arranged to support a plurality of the housings in position so that, when deployed, each housing is configured to contain an oscillating water column which is arranged to be in fluid communication with both the body of water, via a respective opening of the housing, and with an internal flow passage located in the housing.

50. An apparatus for extracting energy from an oscillating working fluid, the apparatus comprising:
a plurality of similarly-configured housings which are positioned on a floatable support structure that is arranged in use to float on a body of water having waves, each housing defining an internal flow passage for receiving the oscillating working fluid;
the housings also being arranged to contain an oscillating water column that is in fluid communication with both the body of water and with the internal flow passage in use, such that the oscillating water column is established within the housing as a result of repeated movements of water from respective incoming and outgoing flows of the waves;
an energy conversion unit disposed at each housing, in fluid communication with the oscillating working fluid in the internal flow passage, such that in use a unidirectional flow of said oscillating working fluid acts on the energy conversion unit at the time of an outgoing wave flowing out; and
a first flow control device also disposed at each housing, in fluid communication with the oscillating working fluid in the internal flow passage, such that in use the flow of the oscillating working fluid exiting the internal flow passage via the flow control device is associated with a rise in pressure therein, caused by an incoming wave flowing from the oscillating water column in the housing; and
a second energy conversion unit which is disposed at each housing, and which is arranged in use to be in fluid communication with the internal flow passage, wherein as the flow of the oscillating working fluid exits the internal flow passage via the first flow control device, it acts on the second energy conversion unit, which is configured to cooperate therewith;
wherein some of the energy conversion units which are disposed at respective adjacent housings are arranged to be placed in operative fluid connection with one another for the transfer of oscillating working fluid therebetween.

51. The apparatus as claimed in claim 50, wherein said operative fluid connection between energy conversion units disposed at adjacent housings also provides a fluid connection for the internal flow passage of each respective housing.

52. The apparatus as claimed in claim 50, wherein said fluid communication between the body of water and the oscillating water column occurs via an opening which is located at a part of the floatable support structure which is continuously submerged below waterline, during normal operational use.

53. Arranging an industrial process or an electrical storage system to be installed on board an apparatus for extracting energy from an oscillating working fluid in accordance with claim 34, wherein in use the industrial process consumes, and/or the storage system stores, at least some of the extracted electrical energy, for end use purposes which include, but are not limited to: desalination of water; electrolysis, or electrolytic conversion, of water; charging of batteries or other long-term energy storage or chemical storage; supporting equipment for windfarms, including associated substations and AC/DC convertors; data centres; and other auxiliary and process equipment for the aforementioned.
